(19) United States
(12) Patent Application Publication
(10) Pub. No.: US 2025/0091145 A1
(43) Pub. Date: Mar. 20, 2025

(54) BLADE FOR RECIPROCATING SAW AND RECIPROCATING SAW

(71) Applicant: MAKITA CORPORATION, ANJO-SHI (JP)

(72) Inventor: Tomohiro UKAI, Anjo-Shi (JP)

(21) Appl. No.: 18/829,892

(22) Filed: Sep. 10, 2024

(30) Foreign Application Priority Data
Sep. 14, 2023 (JP) 2023-149360

(51) Int. Cl. B23D 61/12; B23D 51/10

(52) U.S. Cl. CPC B23D 61/1212; B23D 51/10; B23D 61/123

(57) ABSTRACT

A blade for a reciprocating saw includes: an elongated body having one end that is detachably attachable to the reciprocating saw; and at least one hard tip having a greater hardness than the body and being bonded to the body. The body includes a cutting edge part having a plurality of teeth arranged along the length direction and a back part extending along the length direction on the side opposite to the cutting edge part in a width direction. The cutting edge part includes at least one curved part. The curved part(s) is (are each) configured so that a cutting edge line, which is a line connecting the tips of a plurality of teeth disposed along the curved part(s), curves in a concave manner toward the back part. The at least one hard tip is bonded to at least one of the plurality of teeth.

### CROSS-REFERENCE

The present application priority to Japanese patent application no. 2023-149360 filed on Sep. 14, 2023, the contents of which are incorporated herein by reference.

### TECHNICAL FIELD

The present disclosure relates to a blade that is used by being detachably mounted on a reciprocating saw, and to a reciprocating saw having such a blade.

### BACKGROUND ART

A reciprocating saw is a tool that cuts a workpiece by reciprocating a detachably mounted blade. Various improvements, which are intended to improve the durability of blades for reciprocating saws, are known. For example, Japanese Patent No. 6870730 discloses a blade having a cutting edge part (hard toothed edge) and a back part (back), the cutting edge part including a curved part that curves toward the back part, wherein a diamond layer is formed on the curved part.

### SUMMARY OF THE INVENTION

In the case of the known blade described above, the durability of the blade is improved by providing a curved part along the cutting edge part and by adhering diamond particles to the entire curved part to form a diamond layer. However, a relatively complicated process is required in order to form the diamond layer on the curved part. Therefore, it would be desirable to be able to improve the durability of the blade without using a diamond layer.

In view of the situation described above, one non-limiting object of the present disclosure is to disclose techniques for improving the durability of a blade for a reciprocating saw.

In accordance with one non-limiting aspect of the present disclosure, a blade for a reciprocating saw is provided, the blade comprising an elongated body and at least one hard tip having a greater hardness than the body and being bonded, fused or adhered (e.g., materially bonded) to the body. One end (i.e. the heel) in a length direction of the body is configured so that it can be detachably attached to the reciprocating saw. The body includes a cutting edge part (hard toothed edge) and a back part (back). The cutting edge part has a plurality of teeth arranged along the length direction of the body. The back part extends in the length direction on the side opposite to the cutting edge part in a width direction, which is orthogonal to the length direction of the body.

The cutting edge part includes at least one curved part. The curved part or each of the curved parts is configured so that a cutting edge line thereof curves in a concave manner toward the back part in the width direction. The cutting edge line is a line (i.e. an imaginary or virtual line) connecting (delineating, circumscribing, tracing) tips of a plurality of teeth included in the curved part. The at least one hard tip is bonded to at least one of the plurality of teeth, preferably to some (but not all) of the teeth or to all of the teeth.

In accordance with another non-limiting aspect of the present disclosure, a blade for a reciprocating saw is provided, the blade comprising an elongated body and at least one hard tip having a greater hardness than the body and being bonded to the body. One end (i.e. the heel) in a length direction of the body is configured so that it can be detachably attached to the reciprocating saw. The body includes a cutting edge part (hard toothed edge) and a back part (back). The cutting edge part has a plurality of teeth arranged along the length direction of the body. The back part extends in the length direction on the side opposite to the cutting edge part in a width direction, which is orthogonal to the length direction of the body.

The cutting edge part includes at least one curved part. The curved part includes or the curved parts each include at least a first tooth and a second tooth. In the width direction of the elongated body, a first distance between the tip of the first tooth and the back part differs from a second distance between the tip of the second tooth and the back part. The at least one hard tip is bonded to at least one of the plurality of teeth preferably to some (but not all) of the teeth or to all of the teeth. Here, it is noted that the tips of the first and second teeth are the respective points on the first and second teeth that are farthest from the back part in the width direction.

It is noted that, in the aspects described above, for example, cemented carbide and/or cermet can be suitably employed as the material of the hard tip. One hard tip is typically bonded to one tooth. Thus, if multiple hard tips are employed, the hard tips are typically respectively bonded to an equal number of teeth. The number of hard tips may be the same as the total number of teeth, or may be less than the total number of teeth.

The blade for a reciprocating saw in the aspects described above has a cutting edge part including at least one curved part, and at least one hard tip is bonded to at least one of the plurality of teeth of the cutting edge part. Owing to such a configuration, in addition to the curved part(s) improving the cutting efficiency and durability of the blade, the hard tip(s) can further improve the durability. In addition, because it is relatively easy to selectively bond hard tips to some of, or all of, the plurality of teeth, it is possible to efficiently form parts having a greater hardness than the elongated body in desired positions.

In accordance with another non-limiting aspect of the present disclosure, a reciprocating saw is provided, the reciprocating saw comprising a blade receiving part configured to detachably receive one end (i.e. the heel) of the blade, and a blade according to any one of the aspects described above or any of the embodiments or claims described below, attached to the blade receiving part. This reciprocating saw can use a blade comprising a cutting edge having at least one curved part and at least one hard tip bonded to at least one of a plurality of teeth of the cutting edge part to cut workpieces efficiently and over a long period of time.

### BRIEF DESCRIPTION OF THE DRAWINGS

FIG. 1 is a cross-sectional view of the reciprocating saw in a state in which a blade of a first embodiment is attached.

FIG. 2 is an overall view of the blade of the first embodiment.

FIG. 3 is a partial, enlarged view of the cutting edge part of the blade of FIG. 2.

FIG. 4 is a partial, enlarged view of the cutting edge part of a blade of a second embodiment.

FIG. 5 is a partial, enlarged view of a cutting edge part of a blade of a third embodiment.

FIG. 6 is an overall view of a blade of a fourth embodiment (however, the illustration of the cutting edge part of the blade is simplified).

FIG. 7 is an overall view of a blade of a fifth embodiment (however, the illustration of the cutting edge part of the blade is simplified).

FIG. 8 is an illustration of a variant of the attachment part.

FIG. 9 is an illustration of another variant of the attachment part.

### DETAILED DESCRIPTION

In one non-limiting embodiment of the present disclosure, the curved part(s) in the aspects described above has (each have) a first end in the length direction and a second end, which is at the end opposite to the first end in the length direction. A point on the cutting edge line at which a maximum distance, in the width direction of the body, exists between the cutting edge line and a straight line segment connecting the first end and the second end is preferably less than 15 mm. According to this embodiment, the cutting efficiency and durability can be effectively increased. It is noted that, it is preferable that, the shorter the length of each curved part in the length direction of the body is, the shorter the maximum distance between the line segment connecting the first end and the second end and the cutting edge line will be.

In addition to the embodiment described above, or alternatively to the embodiment described above, the cutting edge part may include a plurality of the curved parts. According to this embodiment, the position of contact with the workpiece during the cutting operation can be easily varied, which is effective for improving durability.

In addition to the embodiments described above, or alternatively to the embodiments described above, the plurality of teeth along the cutting edge part may include a plurality of teeth groups repeatedly disposed along the length direction. Each of the plurality of teeth groups may have an uneven or unequal pitch pattern (sequence) that includes a plurality of pitches that are different from each other. In other words, the cutting edge part may employ a so-called variable pitch or combination pitch. According to this embodiment, vibration and noise due to resonance can be reduced.

In addition to the embodiments described above, or alternatively to the embodiments described above, the at least one hard tip may be bonded to only some of the plurality of teeth of the cutting edge part. In other words, the number of teeth to which a hard tip is bonded may be less than the total number of the plurality of teeth. According to this embodiment, the number of hard tips can be reduced compared to the case in which hard tips are bonded to all of the plurality of teeth, whereby manufacturing costs can be reduced. However, in other embodiments, hard tips may be respectively bonded to every tooth.

In addition to the embodiments described above, or alternatively to the embodiments described above, the body of the blade may have at least one hole, preferably a plurality of holes, e.g., extending along a straight or curved line. According to this embodiment, the hole(s) increase(s) the heat dissipation capability of the elongated body of the blade, which may contribute to further improvement in durability.

In addition to the embodiments described above, or alternatively to the embodiments described above, the reciprocating saw may further comprise a motor and a drive mechanism operatively coupled to the motor and the blade receiving part, the drive mechanism being configured to reciprocate the blade receiving part in a first direction using the motive power of the motor. The length direction of the blade attached to the blade receiving part may be inclined with respect to the first direction, e.g. at an angle of 5-25° with respect to the front-rear direction. According to this embodiment, when cutting, for example, a tubular workpiece (for example, a pipe), the amount of cutting at two places where the blade cuts into the workpiece can be made different.

Non-limiting embodiments of the present disclosure will be described below with reference to the drawings. It is noted that, in the description of the following embodiments and in the referenced drawings, substantially identical configurations (including cases where the shapes are slightly different) are given identical reference numerals and descriptions thereof are omitted or simplified as appropriate.

### First Embodiment

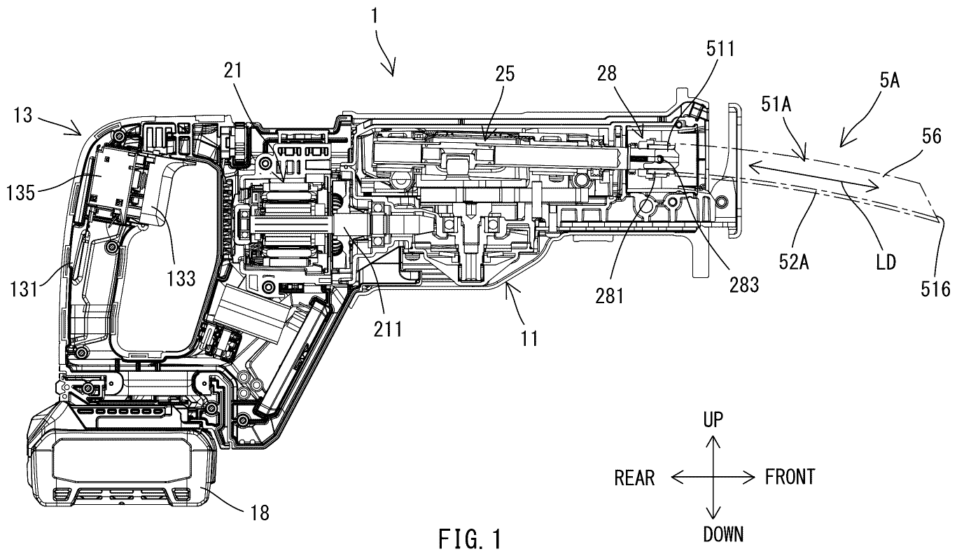

A blade 5A according to the first embodiment will be described below with reference to FIG. 1 to FIG. 3.

The blade 5A is a tool accessory for cutting that is used by being detachably attached to a motorized reciprocating saw. The reciprocating saw 1 shown in FIG. 1 is one non-limiting example of a reciprocating saw to which the blade 5A can be attached. Furthermore, in addition to the blade 5A of the present embodiment, a number of other types of blades can be selectively attached to the reciprocating saw 1. The reciprocating saw 1 is configured to cut a workpiece made of wood, plastic, steel, pipe, or the like by reciprocating the blade.

First, the reciprocating saw 1 will be briefly described. The outer contours of the reciprocating saw 1 are formed by a tool body 11 and a handle 13 connected to the tool body 11.

The tool body 11 is an elongated hollow body. The long axis of the tool body 11 defines the front-rear direction of the reciprocating saw 1. The handle 13 includes a grip part 131 that is gripped by a user. The grip part 131 extends generally orthogonal to the front-rear direction, at the rear of the tool body 11. The direction orthogonal to the long axis of the tool body 11 and corresponding to the direction of extension of the grip part 131 defines the up-down direction of the reciprocating saw 1. A trigger 133 and a switch 135 are provided in the grip part 131. A rechargeable battery 18 can be mounted on the lower end of the handle 13.

A motor 21, a drive mechanism 25, and a blade receiving part 28 are accommodated in the interior of the tool body 11.

While the trigger 133 is pressed by the user and the switch 135 is turned on, the motor 21 is driven. The drive mechanism 25 is operatively coupled to the motor 21 and is driven using the motive power of the motor 21. The drive mechanism 25 includes a motion conversion mechanism configured to convert the rotary motion of an output shaft 211 of the motor 21 into linear (reciprocating) motion of the blade.

The blade receiving part 28 is disposed in the interior of the front end of the tool body 11. The blade receiving part 28 is configured to detachably receive the blade and hold the blade in a fixed manner. Although detailed illustration is omitted, the blade receiving part 28 of the present embodiment comprises a known clamping mechanism that is widely used in various reciprocating saws. This clamping mechanism includes a holder 281, having a slot, and a locking pin 283 that is movable between a locked position protruding into the slot and an unlocked position that does not protrude into the slot.

The blade receiving part 28 is operatively coupled to the drive mechanism 25 (motion conversion mechanism) and reciprocates in a generally front-rear direction, in conjunction with the drive of the motor 21. The blade mounted in the blade receiving part 28 is thereby also reciprocated, and the workpiece can be cut by the reciprocating blade.

The detailed configuration of the blade 5A will be described hereafter.

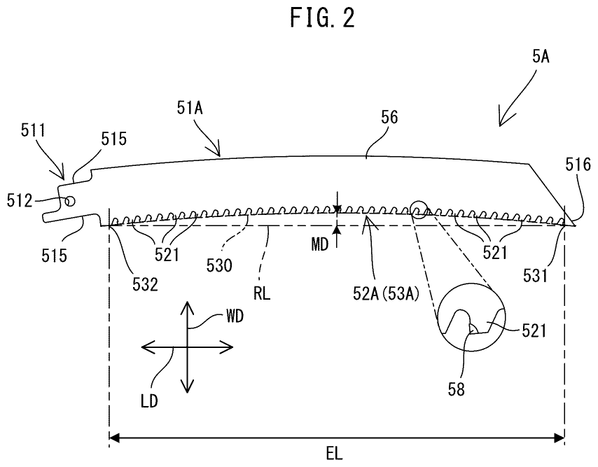

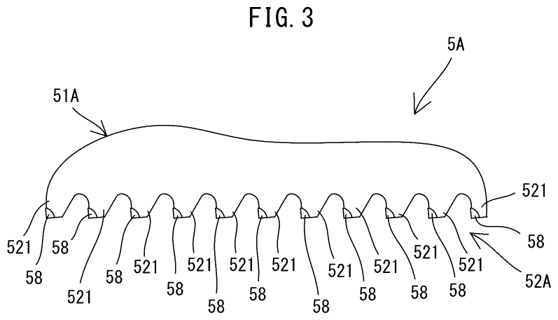

As shown in FIG. 2 and FIG. 3, the blade 5A includes a body 51A and a plurality of hard tips 58 bonded to the body 51A.

The body 51A is an elongated, thin sheet-shaped member having a length, a width, and a thickness, and is also referred to as a substrate. It is noted that the overall lengths of bodies 51A that are widely available on the market are approximately 50 to 400 millimeters (mm), the widths are approximately 5 to 50 mm, and the thicknesses are approximately 0.5 to 2.0 mm.

The body 51A is made of metal and is, for example, formed of steel, preferably a medium or high carbon steel, such as a tool steel or a high speed steel. One end in the length direction LD of the body 51A is configured as an attachment part (heel) 511 that can be attached to the blade receiving part 28. The other end in the length direction LD of the body 51A is a free end (toe) 516.

Although detailed illustration is omitted, in the present embodiment, the attachment part 511 has a size and shape allowing for insertion into the slot of the holder 281 of the blade receiving part 28 (clamping mechanism). The attachment part 511 has a pair of parallel surfaces 515 that extend parallel to each other, spaced apart in the width direction WD of the body 51A. In addition, the attachment part 511 also has an engagement hole 512 in which the locking pin 283 can engage.

When the attachment part 511 of the blade 5A is disposed within the slot, as shown in FIG. 1, the parallel surfaces 515 of the attachment part 511 are disposed along contact surfaces of the holder so as to be substantially orthogonal to an axis extending in the up-down direction. The attachment part 511 is thereby positioned with respect to the blade receiving part 28. When the locking pin 283 is inserted into the engagement hole 512 and locked in the locked position, the body 51A (blade 5A) is held fixed in the blade receiving part 28. When the attachment part 511 is fixed to the blade receiving part 28, the body 51A extends forward, protruding from the tool body 11. It is noted that, in the state in which the attachment part 511 is fixed in the blade receiving part 28, the length direction LD of the body 51A (the long axis of the body 51A) is inclined in a diagonally downward direction with respect to the front-rear direction of the reciprocating saw 1 (the long axis of the tool body 11) toward the front of the reciprocating saw 1, as can be seen in FIG. 1, preferably at an angle of 5-25° with respect to the front-rear direction.

As shown in FIG. 2, the body 51A includes a cutting edge part (hard toothed edge) 52A and a back part (back) 56. The cutting edge part 52A extends between the attachment part 511 and the free end 516 along one edge extending in the length direction LD of the body 51A. The cutting edge part 52A is configured to cut the workpiece, and includes a plurality of teeth 521. It is noted that, in the present embodiment, all of the teeth 521 have the same height and are arranged at the same pitch (which is to say, at equal intervals in the length direction). The back part 56 extends between the attachment part 511 and the free end 516 along the other edge extending in the length direction LD of the body 51A. That is to say, the back part 56 is provided along the edge on the side opposite to the cutting edge part 52A in the width direction WD of the body 51A.

The cutting edge part 52A includes a curved part 53A. The curved part 53A is a portion of the cutting edge part 52A where a line (hereinafter referred to as the cutting edge line 530) connecting (tracing, intersecting) the tips (tooth tips, i.e. lowermost portions in FIGS. 2 and 3) of the teeth 521 is not a straight line, but rather is curved in a concave manner toward the back part 56.

The cutting edge part 52A of the present embodiment is designed such that the entire cutting edge part 52A is configured as a curved part 53A. More specifically, the cutting edge line 530 of the curved part 53A (the cutting edge part 52A) is curved in a concave manner toward the back part 56 in the width direction WD, with respect to a reference line RL for the curved part 53A. The reference line RL is a straight line segment connecting, in the length direction LD, a first end 531 of the curved part 53A, which is located on the end that is the free end 516, and a second end 532 (the end having the attachment part 511) at the opposite end. The curvature (or radius of curvature) of the cutting edge line 530 is substantially constant. The point on the cutting edge line at which the maximum distance MD between the reference line RL and the cutting edge line 530 in the width direction WD exists is found (located) at a substantially central position in the length direction LD of the curved part 53A.

It is noted that this point on the cutting edge line that is at the maximum distance MD is preferably less than 15 millimeters (mm) from the reference line RL in order to improve cutting performance and durability. In addition, the maximum distance MD is preferably set (determined) in accordance with the entire length EL of the curved part 53A (the distance between the first end 531 and the second end 532). More specifically, it is preferable that, the shorter the entire length EL is, the shorter the maximum distance MD will be. For example, if the entire length EL is 100 mm or more and less than 200 mm, the point on the cutting edge line at which the maximum distance MD exists is preferably in the range of 0.4 to 5 mm (including 0.4 and 5 mm) from the reference line RL. If the entire length EL is 200 mm or more and less than 300 mm, the point on the cutting edge line at which the maximum distance MD exists is preferably in the range of 1.5 to 9 mm (including 1.5 and 9 mm) from the reference line RL. If the entire length EL is 300 mm or more and less than 400 mm, the point on the cutting edge line at which the maximum distance MD exists is preferably in the range of 3 to 12 mm (including 3 and 12 mm) from the reference line RL. Thus, it is preferable that the curved part 53A is configured or designed such that the point, which is at the maximum distance MD from the reference line RL, on the (curved) cutting edge line 530 is at least 0.4 mm from the reference line RL.

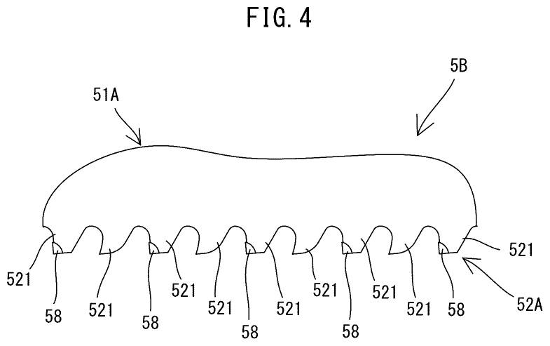

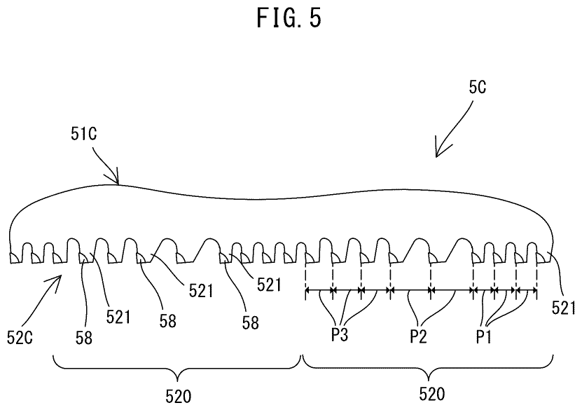

The hard tip 58 is a tip formed of a material that is harder (i.e. has a greater hardness, e.g., Vicker's hardness (HV)) than the body 51A. It is noted that the material of the hard tip 58 is not particularly limited, but, for example, cemented carbides (e.g., tungsten carbide) and cermets (i.e. a composite material composed of ceramic and metal materials, such as titanium nitride (TiN), titanium carbonitride (TiCN) or titanium carbide (TiC)) can be preferably employed. As shown in FIG. 3, the hard tip 58 is smaller than the tooth 521 of the cutting edge part 52A. In the present embodiment, one hard tip 58 is bonded to each tip part of all of the teeth 521. More specifically, the hard tips 58 are bonded to the tip part of each tooth 521 on the side closest to the attachment part 511, in the length direction LD of the body 51A. The method of attaching the hard tip 58 to the tooth 521 is not particularly limited; for example, welding or brazing can preferably be used. It is noted that, in FIG. 3, although a cutting edge line connecting the tips of the teeth 521 appears to be nearly straight, in fact, overall the blade 5A is intended to have the same curvature as the cutting edge line 530 in FIG. 2. This understanding also applies to the blades of FIGS. 4 and 5. Furthermore, it is noted that the wavy line on the upper portion of the blade in in FIGS. 3-5 is merely intended to represent that FIGS. 3-5 show cutaway views; the back part of each of these blades is intended to be configured, shaped or designed in the same manner as the curved back part 56 shown in FIG. 2.

As described above, the blade 5A of the present embodiment has a cutting edge part 52A including a curved part 53A, and hard tips 58 are bonded to each of the teeth 521 of the cutting edge part 52A. Owing to such a configuration, in addition to the curved part 53A improving the cutting efficiency and durability of the blade 5A, the hard tips 58 can further improve the durability. In addition, since it is relatively easy to bond the hard tips 58 to the body 51A, parts having greater hardness than the body 51A can be efficiently formed at desired positions of the body 51A.

### Second Embodiment

A blade 5B according to the second embodiment will be described below with reference to FIG. 4.

The blade 5B of the present embodiment differs from the blade 5A of the first embodiment only with regard to the number of hard tips 58 attached to the body 51A. More specifically, as shown in FIG. 4, the blade 5B has hard tips 58 bonded to every other tooth 521 of the cutting edge part 52A, rather than to all of the plurality of the teeth 521. The number of hard tips 58 can thereby be reduced as compared to the blade 5A of the first embodiment, thereby allowing manufacturing costs to be reduced.

It is noted that, instead of the example described above, for a plurality of teeth 521, for example, one hard tip 58 may be bonded for every specific number of teeth 521 (e.g., every second tooth, every third tooth, or the like). Alternatively, for every specific number of teeth 521, one hard tip 58 may be bonded to each of a plurality of teeth 521 that is less than that number (for example, three teeth 521 out of five teeth 521). Alternatively, for example, depending on the object to be cut by the blade 5B, the hard tips 58 may be bonded at a greater density in one or more particular portions within the plurality of teeth 521 that is/are prone to premature wear (for example, the end of the curved part 53A closer to the attachment part 511, the central part of the curved part 53A, the end of the curved part 53A closer to the free end 516, or the like) than in (an) other portion(s).

### Third Embodiment

A blade 5C according to the third embodiment will be described below with reference to FIG. 5.

The blade 5C of the present embodiment differs from the blade 5A of the first embodiment only in the configuration of the cutting edge part 52C of the body 51C. More specifically, as shown in FIG. 5, the cutting edge part 52C of the present embodiment includes a plurality of teeth groups 520 repeatedly disposed along the length direction LD. Each teeth group 520 includes a plurality of teeth 521. One hard tip 58 is bonded to every tooth 521, although again it is not necessary to bond hard tips 58 to every tooth 521.

The blade 5C of the present embodiment has a so-called variable pitch or combination pitch. That is to say, the plurality of teeth 521 of each teeth group 520 are arranged at uneven or unequal intervals, rather than at equal intervals, on the blade 5C.

More specifically, each teeth group 520 includes nine teeth 521 in total. Among the nine teeth 521, the distance (pitch) between the tip of each of the first to third teeth 521 from the free end 516 in the length direction LD (right side of the figure) and the tip of the tooth 521 adjacent to this tooth 521 on the attachment part 511 side (left side of the figure) is an identical first pitch P1; i.e. the distances between each of the first to fourth teeth 521 equal (P1). The distance (pitch) between the tip of each of the fourth to fifth teeth 521 from the free end 516 and the tip of the tooth 521 adjacent to this tooth 521 on the attachment part 511 side is an identical second pitch P2, which is greater than the first pitch P1; i.e. the distances between each of the fourth to sixth teeth 521 is equal (P2). The distance (pitch) between the tip of each of the sixth to eighth teeth 521 from the free end 516 and the tip of the tooth 521 adjacent to this tooth 521 on the attachment part 511 side is an identical third pitch P3, which is greater than the first pitch P1 and less than the second pitch P2; i.e. the distances between each of the six to ninth teeth 521 is equal (P3).

Thus, in the present embodiment, for each teeth group 520, a pitch pattern (repetitive sequence) that includes a first pitch P1, a second pitch P2, and a third pitch P3, which are different from each other, is defined. Furthermore, two or more of the teeth groups 520 are then preferably repeatedly disposed along the length direction LD.

It is noted that the pitch of the teeth 521 may also be expressed in terms of the number of teeth 521 or points (tips) per inch (TPI). In this case, it can be said that each teeth group 520 includes three sections, in which the TPI is the greatest, the least, and intermediate, in that order from the free end 516 in the length direction LD. For example, the TPI of the section closest to the free end 516 can be set to 14, the TPI of the middle section can be set to 10, and the TPI of the section furthest from the free end 516 can be set to 12.

As described above, the blade 5C in the present embodiment has an uneven pitch pattern. The uneven pitch pattern can effectively reduce vibration and noise due to resonance. It is noted that the pitch pattern described above is merely illustrative, and the number and/or pitch of the teeth 521 in the teeth group 520 may be changed as appropriate. In addition, the arrangement of the hard tips 58 described in the second embodiment may also be combined with the configuration having an uneven pitch pattern of the present embodiment.

### Fourth Embodiment

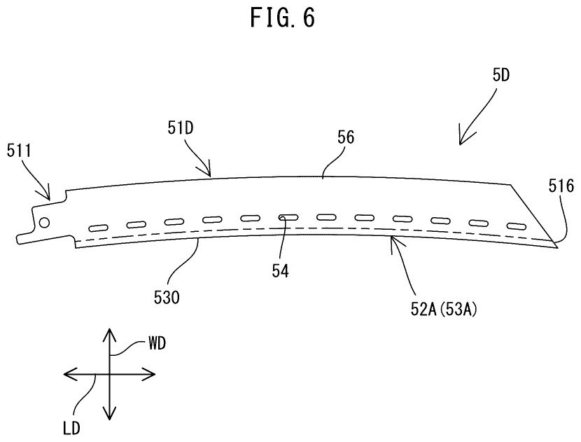

A blade 5D according to the fourth embodiment will be described below with reference to FIG. 6. It is noted that, in FIG. 6, illustration of the teeth 521 of the cutting edge part 52A is omitted, and only the cutting edge line 530 is illustrated.

The blade 5D of the present embodiment differs from the blade 5A of the first embodiment only in that the body 51D has holes 54. More specifically, as shown in FIG. 6, a plurality of holes 54 are arranged along the length direction LD between the cutting edge part 52A and the back part 56 of the body 51D in the width direction WD. The holes 54 are each elongated in the length direction LD. These holes 54 can contribute to improving heat dissipation and chip removal. The holes 54 may be arranged, e.g., along a straight line or an arc.

It is noted that the shape, number, and arrangement of the holes 54 can be changed as appropriate in accordance with the object of cutting, the strength of the body 51A, and the like. In addition, the arrangement of the hard tips 58 described in the second embodiment and/or the uneven pitch pattern described in the third embodiment may be combined with the configuration of the present embodiment.

### Fifth Embodiment

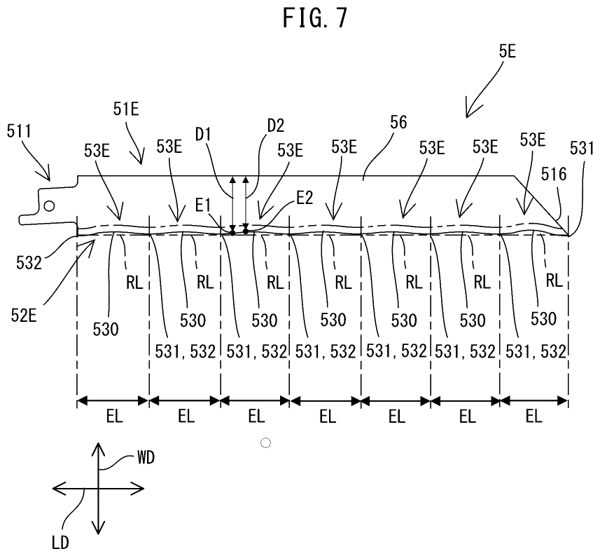

A blade 5E according to the fifth embodiment will be described below with reference to FIG. 7. It is noted that, in FIG. 7, illustration of the teeth 521 of the cutting edge part 52E is omitted, and only the cutting edge line 530 is illustrated.

The blade 5E of the present embodiment differs from the blade 5A of the first embodiment only in the configuration of the cutting edge part 52E of the body 51E. More specifically, although detailed illustration is omitted, the cutting edge part 52E of the present embodiment includes a plurality of teeth 521 that have the same height and are disposed at the same pitch (equal intervals), in the same manner as in the first embodiment. In addition, a hard tip 58 is bonded to each of the tip parts of all of the teeth 521, in the same manner as in the first embodiment (see FIG. 3).

In addition, different from the first embodiment, the cutting edge part 52E in the present embodiment includes a plurality of curved parts 53E that are arranged along the length direction LD. The curved parts 53E each have substantially the same shape. The cutting edge line 530 of each curved part 53E is curved in a concave manner toward the back part 56 in the width direction WD, with respect to a reference line RL connecting the first end 531 and the second end 532. It is noted that, in the present embodiment, the reference lines RL for all the curved parts 53E are on the same straight line.

Similar to the first embodiment (see FIG. 2), in the blade 5E of the present embodiment as well, a point on the cutting edge line that is at the maximum distance MD between the reference line RL of each curved part 53E and the cutting edge line 530 for the same curved part 53E in the width direction WD is found (located) at (within) the central part of each curved part 53E in the length direction LD. The entire length EL of each curved part 53E is approximately 10 mm to 50 mm, which is shorter than the entire length EL of the curved part 53A in the first embodiment. Therefore, the maximum distance MD is smaller than the maximum distance MD of the curved part 53A of the first embodiment, and is set at approximately 0.2 mm to 5 mm. Thus, in embodiments of the present teachings in which the blade has multiple curved parts 53E, it is preferable that each of the curved parts 53E is configured or designed such that the point, which is at the maximum distance MD from the reference line RL for the respective curved part 53E, on the (curved) cutting edge line 530 for the respective curved part 53E is at least 0.2 mm from the reference line RL for the respective curved part 53E.

In addition, in the present embodiment, the edge along the back part 56 of the body 51E is straight. Thus, from among the plurality of teeth 521 included on each curved part 53E, the respective distances between at least two tips (of a first tooth and a second tooth) and the back part 56 (specifically, the edge along the back part 56 of the body 51E) are different from each other. In other words, the distance D1 between the tip E1 of the first tooth and the edge along the back part 56 and the distance D2 between the tip E2 of the second tooth and the edge along the back part 56 are different. It is noted that, because detailed illustration of the teeth 521 is omitted in FIG. 7, the tips E1, E2 are illustrated as dots on the cutting edge line 530.

It is noted that, in the present embodiment, the curvature of the cutting edge line 530 is set to be smaller towards the ends of the curved part 53E, so that the cutting edge lines 530 of adjacent curved parts 53E continue in a gently wave-shaped manner. However, the shape of the cutting edge line 530 is not limited to this example and may be changed at will. In addition, although illustration is omitted, one or more of longitudinally adjacent ones of the curved parts 53E may be connected via a straight part, constituting a straight line connecting the tips of teeth 521. In addition, at least one of the arrangement of the hard tips 58 described in the second embodiment, the uneven pitch pattern described in the third embodiment, and the holes 54 described in the fourth embodiment may be combined with the configuration of the present embodiment.

As described above, the cutting edge part 52E of the blade 5E in the present embodiment includes a plurality of curved parts 53E. Therefore, the position of contact with the workpiece during the cutting operation can be easily varied, which is effective in improving durability.

It is noted that the embodiments described above are merely illustrative, and blades according to the present disclosure are not limited to the illustrated blades 5A, 5B, 5C, 5D, and 5E. For example, it suffices that the body of the blade is designed such that the cutting edge line of the at least one curved part of the cutting edge part is curved in a concave manner toward the back part, and the entire length, width, thickness, pitch of the teeth, material, and the like of the body can be changed as appropriate. In addition, the shape, size, number, arrangement, and material of the hard tips may also be changed as appropriate.

In addition, it suffices that one end in the length direction of the body is detachably attachable to a reciprocating saw (without limitation to the reciprocating saw 1 in the embodiment described above), and the configuration thereof is not limited to the aforementioned attachment part 511. For example, the attachment part 511 may be modified as appropriate depending on the configuration of the blade receiving part 28 and/or the mode of use of the blade.

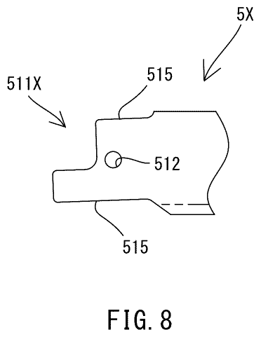

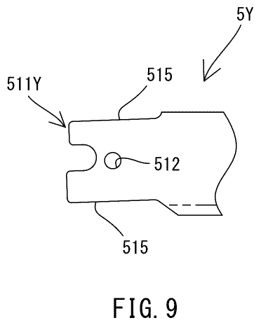

For example, FIG. 8 and FIG. 9 illustrate attachment parts 511X and 511Y of blades 5X and 5Y for a reciprocating saw, each of which is used together with a chain vice. The chain vice is used by being attached to the tool body of the reciprocating saw, in a state in which the workpiece (that is the object to be cut) is fixed with the chain. When the cutting operation by the blade 5X/5Y is carried out in this state, the attachment part 511X/511Y is subjected to a large load. Accordingly, the attachment part 511X/511Y is configured to be wider (with a wider spacing of the parallel surfaces 515) than the attachment part 511 shown in FIG. 2 to ensure the required strength.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved blades for reciprocating saws.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMERALS

1: reciprocating saw, 11: tool body, 13: handle, 131: grip part, 133: trigger, 135: switch, 18: battery, 5A, 5B, 5C, 5D, 5E, 5X, 5Y: blade, 21: motor, 211: output shaft, 25: drive mechanism, 28: blade receiving part, 281: holder, 283: locking pin, 51A, 51C, 51D, 51E: body, 511, 511X, 511Y: attachment part, 512: engagement hole, 515: parallel surface, 516: free end, 52A, 52C, 52E: cutting edge part, 520: teeth group, 521: tooth, 53A, 53E: curved part, 530: cutting edge line, 531: first end, 532: second end, 54: hole, 56: back part, 58: hard tip, EL: entire length of curved part, RL: reference line

1. A blade for a reciprocating saw, comprising:
an elongated body configured so that one end in a length direction of the body is detachably attachable to the reciprocating saw; and
at least one hard tip having a greater hardness than the body and being bonded to the body,
wherein:
the body includes a cutting edge part having a plurality of teeth arranged along the length direction and a back part extending along the length direction on the side opposite to the cutting edge part in a width direction, which is orthogonal to the length direction;
the cutting edge part includes at least one curved part;
the curved part(s) is (are each) configured so that a cutting edge line, which is a line connecting tips of a plurality of teeth included in the curved part(s), curves in a concave manner toward the back part; and
the at least one hard tip is bonded to at least one of the plurality of teeth.

2. The blade according to claim 1, wherein:
the curved part(s) has (each have) a first end in the length direction and a second end that is at the end opposite to the first end in the length direction; and
in the width direction, a point on the cutting edge line at which a maximum distance exists between the cutting edge line of the curved part or at least one of the curved parts, and a straight line segment, which connects the first end and the second end of the curved part(s), is less than 15 mm from the straight line segment.

3. The blade according to claim 1, wherein:
the cutting edge part includes a plurality of the curved parts.

4. The blade according to claim 1, wherein:
the plurality of teeth of the cutting edge part include a plurality of teeth groups repeatedly disposed along the length direction; and
each of the plurality of teeth groups has an uneven pitch pattern that includes a plurality of pitches that are different from each other.

5. The blade according to claim 1, wherein:
the at least one hard tip is bonded to some, but not all, of the plurality of teeth of the cutting edge part.

6. The blade according to claim 1, wherein:
the at least one hard tip is bonded to all of the plurality of teeth of the cutting edge part.

7. The blade according to claim 1, wherein:
the body has at least one hole disposed between the teeth and the back part in the width direction.

8. The blade according to claim 1, wherein:
the body has a plurality of holes disposed between the teeth and the back part in the width direction.

9. The blade according to claim 1, wherein:
the body is made of steel; and
the at least one hard tip is composed of cemented carbide or cermet.

10. A reciprocating saw comprising:
a blade receiving part; and
the blade according to claim 1 detachably attached to the blade receiving part.

11. The reciprocating saw according to claim 10, further comprising
a motor; and
a drive mechanism operatively coupled to the motor and the blade receiving part, the drive mechanism being configured to reciprocate the blade receiving part in a first direction using motive power of the motor,
wherein the length direction of the blade attached to the blade receiving part is inclined with respect to the first direction.

12. A blade for a reciprocating saw, comprising:
an elongated body configured so that one end in a length direction of the body is detachably attachable to the reciprocating saw; and
at least one hard tip having a greater hardness than the body and being bonded to the body,
wherein:
the body includes a cutting edge part having a plurality of teeth arranged along the length direction and a back part extending along the length direction on the side opposite to the cutting edge part in a width direction, which is orthogonal to the length direction;
the cutting edge part includes at least one curved part;
the curved part(s) (each) include(s) at least a first tooth and a second tooth;
in the width direction, a first distance between a tip of the first tooth and the back part differs from a second distance between a tip of the second tooth and the back part; and
the at least one hard tip is bonded to at least one of the plurality of teeth.

13. The blade according to claim 12, wherein:
the curved part(s) has (each have) a first end in the length direction and a second end that is at the end opposite to the first end in the length direction; and
in the width direction, a point on the cutting edge line at which a maximum distance exists between a cutting edge line, which is a line connecting the tips of a plurality of teeth included in the curved part(s), and a straight line segment, which connects the first end and the second end of the curved part(s), is less than 15 mm from the straight line segment.

14. The blade according to claim 12, wherein:
the cutting edge part includes a plurality of the curved parts.

15. The blade according to claim 12, wherein:
the plurality of teeth of the cutting edge part include a plurality of teeth groups repeatedly disposed along the length direction; and
each of the plurality of teeth groups has an uneven pitch pattern that includes a plurality of pitches that are different from each other.

16. The blade according to claim 12, wherein:
the at least one hard tip is bonded to some, but not all, of the plurality of teeth of the cutting edge part.

17. The blade according to claim 12, wherein:
the body has at least one hole disposed between the teeth and the back part in the width direction.

18. A reciprocating saw comprising:
a blade receiving part; and
the blade according to claim 12 detachably attached to the blade receiving part.

19. The reciprocating saw according to claim 18, further comprising
a motor; and
a drive mechanism operatively coupled to the motor and the blade receiving part, the drive mechanism being configured to reciprocate the blade receiving part in a first direction using the motive power of the motor,
wherein the length direction of the blade attached to the blade receiving part is inclined with respect to the first direction.

20. The blade according to claim 2, wherein the point is at least 0.2 mm from the straight line segment.
